(19) United States
(12) Patent Application Publication
(10) Pub. No.: US 2008/0320423 A1
(43) Pub. Date: Dec. 25, 2008

(54) SYSTEM AND METHOD TO PROTECT COMPUTING SYSTEMS

(75) Inventors: Elie Awad, Essex Junction, VT (US); Mariette Awad, Essex Junction, VT (US); Adam E. Trojanowski, Essex Junction, VT (US); Sebastian T. Ventrone, South Burlington, VT (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/873,754

(22) Filed: Oct. 17, 2007

Related U.S. Application Data
(63) Continuation-in-part of application No. 11/767,545, filed on Jun. 25, 2007.

(51) Int. Cl. G06F 17/50

(52) U.S. Cl. 716/5

(57) ABSTRACT

A system and method for protecting computing systems, and more particularly a system and method which a dedicated hardware component configured to communicate with a protection program. A computer hardware subsystem includes a memory comprising content. The content is at least a list of files which have been modified within a predetermined period of time. The list of files is a subset of files of a hard drive. A dedicated hardware component is configured to track the files which have been modified and provide a location of the files to the memory. A communication link between the dedicated hardware component and a protection program provides the protection program with the subset of files of the hard drive as referenced by the memory content. The invention is also directed to a design structure on which a circuit resides.

### CROSS-REFERENCE TO RELATED APPLICATIONS

The present application is a continuation in part of U.S. application Ser. No. 11/767,545, filed on Jun. 25, 2007, the disclosure of which is expressly incorporated by reference herein in its entirety.

### FIELD OF THE INVENTION

The invention relates to a system and method for protecting computing systems, and more particularly to a dedicated hardware component configured to communicate with a protection program. The invention is also directed to a design structure on which a circuit resides.

### BACKGROUND DESCRIPTION

Antivirus and other protection software (hereinafter referred generally to as “protection software”) are designed to identify, thwart and eliminate computer viruses and other malicious software (malware) such as, for example, computer worms, Trojan horses and other malicious attacks on a computing system. As should be known, a computer virus can replicate itself and infect a computing system, and can spread to other computing systems by infecting files on a network file system or a file system that is accessed by another computer. Some viruses are programmed to damage programs, delete files, etc.; whereas, other viruses are designed to simply replicate themselves and make their presence known by presenting text, video, or audio messages.

In any event, protection software typically uses two techniques to identify, thwart and eliminate computer viruses and other malicious software (malware). These techniques include:

Examining (scanning) files to look for known viruses matching definitions in a virus dictionary; and

Identifying suspicious behavior from any computer program which might indicate infection. Such analysis may include data captures, port monitoring and other methods.

Most protection software uses both of these approaches, with an emphasis on the virus dictionary approach.

Using the known techniques, the known protection software reduces computing performance by making considerable demands on resources. For example, in operation the known protection programs load to the operating system and, once loaded, begin the scan of the physical hardware and software. The known protection programs, though, scan 100% of the files, with all of the files being marked regardless of whether the files were previously accessed and/or updated. Although this provides 100% protection, it also uses a considerable amount of resources.

Moreover, known protection programs are tightly coupled into the existing operating system of the computing system. These programs are thus visible to the operation. In such situation, unbeknownst to the user or protection software, malicious scripts can be downloaded to “fool” the operating system into believing that a scan was performed when, in fact, the scan was not performed by the protection software. In these cases, the protection software will report a “pass” scan to the user, even though a scan was never performed.

Accordingly, there exists a need in the art to overcome the deficiencies and limitations described hereinabove.

### SUMMARY OF THE INVENTION

In a first aspect of the invention, a subsystem comprises a dedicated hardware component configured to track modified locations of a hard drive and to provide a list of the modified locations to a protection program independent of an operating system. The modified locations are a subset of files of the hard drive.

In another aspect of the invention, a computer hardware subsystem comprises a memory comprising content. The content is at least a list of files which have been modified within a predetermined period of time. The list of files is a subset of files of a hard drive. A dedicated hardware component is configured to track the files which have been modified and provide a location of the files to the memory. A communication link between the dedicated hardware component and a protection program provides the protection program with the subset of files of the hard drive as referenced by the memory content.

In yet another aspect of the invention, a method comprises tracking files which have been updated and logging a location of the tracked files in a memory log. The method further includes retrieving the location of the tracked files from the memory log and providing the location to a protection program for scanning of the tracked files.

In yet another aspect of the invention, a design structure is embodied in a machine readable medium for designing, manufacturing, or testing a design. The design structure comprises: a memory comprising content, the content being at least a list of files which have been modified within a predetermined period of time, the list of files being a subset of files of a hard drive; a dedicated hardware component configured to track the files which have been modified and provide a location of the files to the memory; and a communication link between the dedicated hardware component and a protection program to provide the protection program the subset of files of the hard drive as referenced by the memory content.

In embodiments, the design structure comprises a netlist, which describes the circuit. The design structure resides on storage medium as a data format used for the exchange of layout data of integrated circuits. The design structure includes at least one of test data files, characterization data, verification data, or design specifications. The design structure further comprises a component for: tracking modified locations of a hard drive; and providing a list of the modified locations to a protection program independent of an operating system. The modified locations are a subset of files of the hard drive.

### BRIEF DESCRIPTION OF THE DRAWINGS

FIG. 1 is representative of a system implementing the invention;

FIG. 2 shows an exemplary log in accordance with the invention;

FIG. 3 shows an exemplary architecture in accordance with the invention;

FIG. 4 shows another exemplary architecture in accordance with the invention;

FIGS. 5-8 show exemplary flow diagrams implementing processing steps in accordance with embodiments of the invention; and

FIG. 9 is a flow diagram of a design process used in semiconductor design, manufacturing, and/or test.

### DETAILED DESCRIPTION OF EMBODIMENTS OF THE INVENTION

The invention relates to a system and method for protecting computing systems, and more particularly to a system and method comprising a dedicated hardware component configured to communicate with a protection program (e.g., anti virus application). In embodiments, the dedicated hardware component is a circuit which is configured to track modified locations of a hard disk drive(s) and store a list of the modified locations in a memory, e.g., non volatile random access memory (NVRAM). The dedicated hardware component provides the list of modified locations to the protection program by a secure communication link, via a communication protocol. From reset to shutdown, only the protection program can access the modified data from the dedicated hardware component, thereby providing a separate wall of operation independent of the operating system.

By implementing the system and method of the invention, an antivirus scan, for example, can be a subset of the total hard drive as referenced by NVRAM content, e.g., only the files on a list stored in memory. This saves considerable resources and considerably reduces scan times; compared to scanning each and every file, regardless of whether the file was previously accessed or updated. In embodiments, the list can be updated and deleted at predetermined times. For example, the list can be deleted after a successful scan.

In operation, the activities of the dedicated hardware component and the protection program are independent of the operating system of the computing system and can be implemented in a memory structure or other circuit. This ensures that the protection program performs its intended functions, e.g., scans the files, regardless of whether the operating system is corrupted by a virus or other malicious attack. Thus, in implementation, the operating system is isolated from the scanning operations thus eliminating the known operating system risks. Additionally, as the operating system is isolated, it cannot write or change any information in the dedicated hardware component, thereby providing another level of protection.

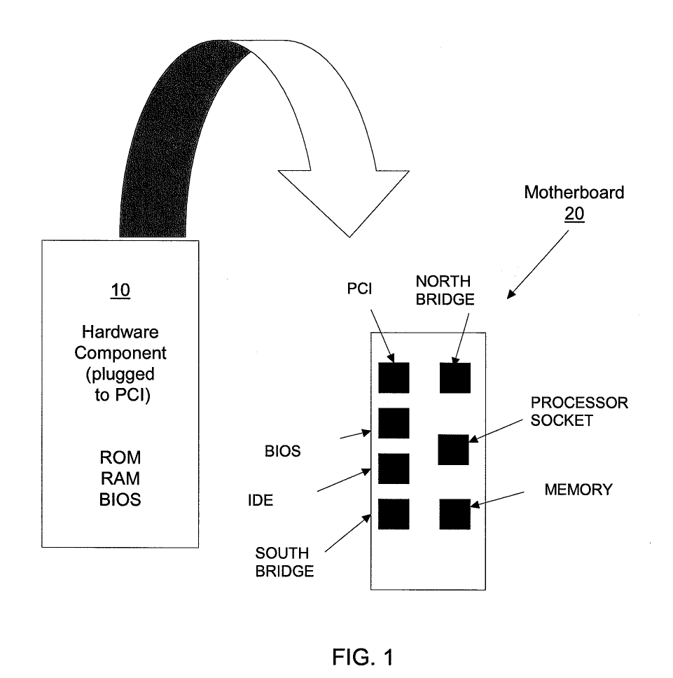

FIG. 1 is representative of a system implementing the invention. In particular, a dedicated hardware component 10 of the invention is plugged into a conventional PCI (peripheral component interconnect) board 20. The dedicated hardware component 10 is a plug and play device, which interfaces with the conventional PCI board 20 and is easily integrated into most available platforms. The dedicated hardware component 10 can be embodied as a circuit layout as should be understood by those of skill in the art.

In embodiments, the dedicated hardware component 10 (also referred to as an IDE “Integrated Drive Electronics” controller) includes a ROM, RAM, processing unit and BIOS (implemented in a circuit). The BIOS is configured to intercept the write application from the operating system to the hard drive, and maintain the files being accessed (updated) for future scanning. The system is also configured in such a manner that only the protection program can access the data on the ROM and RAM of the dedicated hardware component 10. In further embodiments, the protection program can only access the ROM and RAM via an encryption key. In this way, only the user which passes the encryption to the installed protection program can use the information on the dedicated hardware component 10.

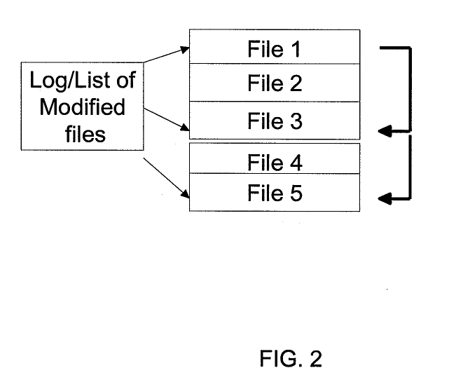

As discussed above, the dedicated hardware component 10 maintains track of the physical drive locations of updated files from reset to shutdown. By doing so, the dedicated hardware component 10 can log specific information (location) related to the write operations of the updated files in the memory (e.g., NVRAM). It should be understood that the updated files are files which are potentially infected with a virus or malware. For example, FIG. 2 shows a log (list of files) which was updated during operations. This log includes potentially infected files. In the example of FIG. 2, the list includes file 1, file 3 and file 5, all of which had write operations performed thereon. After the files in the log are scanned, they can be deleted.

Moreover, for any hard drive writes and as an added layer of security, a CRC code can be stored in the memory (e.g., NVRAM) so that during the scan, the file can be confirmed to be the same file as was written earlier. As should be understood, a CRC (Cyclic Redundancy Check) is a type of hash function used to produce a checksum in order to detect errors in transmission or storage. The dedicated hardware component 10 is also configured for data journaling, i.e., writing old versions of the files to back up storage for later recovery.

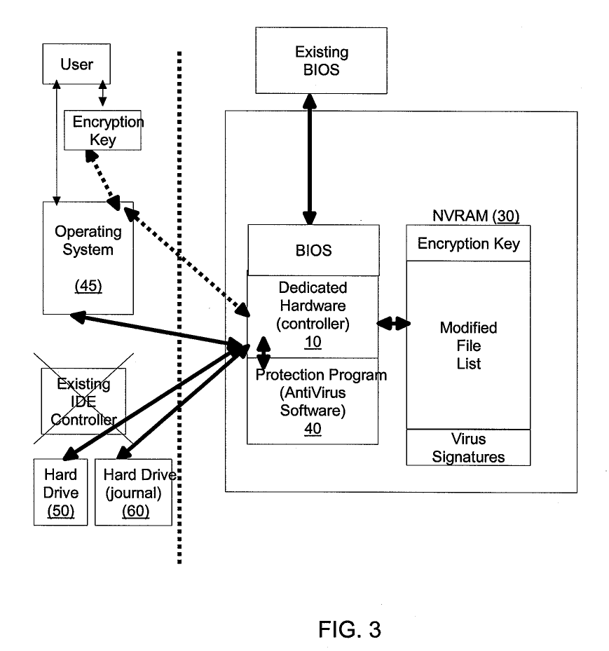

FIG. 3 shows an exemplary architecture in accordance with the invention. In FIG. 3, the dedicated hardware component 10 communicates with the PCI board (not shown) via the existing BIOS. This can be accomplished through a script, which can be implemented by one of skill in the art and, as such, is not discussed further herein. The communication between the existing BIOS and the dedicated hardware component 10 allows for secure updating of the protection program 40, as well as updating of encryption keys and other security features contemplated by the invention. Thus, in embodiments, a private key can exist within the BIOS, and the public key can be on the protection program 40. For security reasons, the encryption key is stored in the memory 30. The memory 30 also stores the virus signatures, in one embodiment, as discussed in more detail below.

The dedicated hardware component 10 also replaces the existing IDE controller on the PCI board and, as such, will handle reading/writing operations to the hard drives 50 and 60. The hard drive 60 is configured to store (journal) files prior to scanning.

As discussed, the dedicated hardware component 10 also tracks the files that are accessed and/or updated in the hard drives 50 and writes these files to a log (list) in the memory 30. The memory 30 stores the list for later access by the dedicated hardware component 10. The dedicated hardware component 10 also communicates with the user through the operating system 45 via encryption. The user is also capable of communicating directly with the operating system 45 to gain access to files on the hard drive, during normal operations.

At scan time, e.g., at the request of the user, the protection program 40 will request the list from the dedicated hardware component 10 which, in turn, retrieves the list from the memory 30. In embodiments, the protection program 40 can communicate via encrypted communication with the dedicated hardware component 10. By allowing the protection program 40 to communicate directly with the dedicated hardware component 10, it is now possible to bypass the operating system 45 thus providing a more secure and robust system independent of the operating system 45. Accordingly, it is possible to reduce the dependency on the operating system, for the reasons already discussed herein.

In one specific implementation, at scan time the protection program 40 will query the dedicated hardware component 10, which communicates with the memory 30, to locate the first valid scan location on the hard drive 50. Once the first valid location is scanned, the protection program 40 will query the dedicated hardware component 10 for the next valid location, until all modified files have been scanned on the hard drive 50. By scanning only the valid files, it is possible to reduce resource consumption, amongst other features.

Thus, in embodiments, the dedicated hardware component 10 includes many embedded functions as already discussed. By way of non-limiting illustrative example, the dedicated hardware component 10 is configured to (i) read data from hard disk bus and determine file changes, (ii) record in the memory 30 the pointer to the changed file with date stamp information, (iii) encrypt communications intended for the protection program through the operating system, (iv) update the file list in the memory with information from the protection program, e.g., virus signatures, (v) communicate with the BIOS to receive delinquent file dates, and (vi) alert the user via the BIOS if the protection program has not cleared the file from memory 30 within a user specified timeframe.

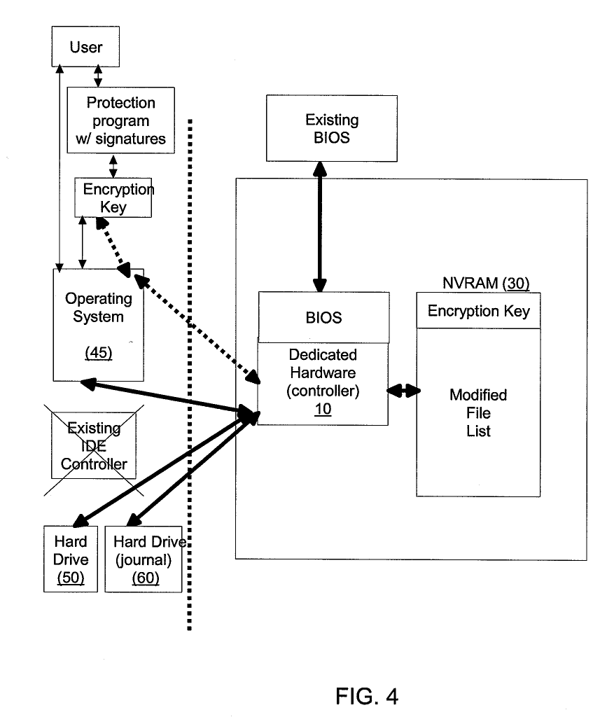

FIG. 4 shows another exemplary architecture in accordance with the invention. In the implementation of FIG. 4, the protection program 40 is provided between the user and the encryption key. In this architecture, the signatures of the protection program 40 are resident on the protection program 40. In this embodiment, the dedicated hardware component 10 still (i) replaces the existing IDE controller on the PCI board and, as such, will handle reading/writing operations to the hard drives 50 and 60, (ii) tracks the files that are accessed and/or updated in the hard drive 50 and writes these files to a list in the memory 30 for later access by the dedicated hardware component 10, and (iii) communicates with the user and protection program 40 through the operating system 45 via encryption.

As with the previous embodiments, the dedicated hardware component 10 communicates with the PCI board (not shown) via the existing BIOS. As described, this can be accomplished through a script which allows such communication, directly, with the existing BIOS. The communication between the existing BIOS and the dedicated hardware component 10 allows for secure updating of encryption keys and other security features contemplated by the invention. The encryption key can still be stored in the memory 30.

In the implementation of FIG. 4, the protection program 40 will query the dedicated hardware component 10, via encryption, to locate the first valid scan location on the hard drive 50. Once the first valid location is scanned, the protection program 40 will query the dedicated hardware component 10 for the next valid location, until all modified files have been scanned on the hard drive 50. In this and other embodiments, the protection program 40 can hand off its responsibilities, e.g., scanning operations, to the dedicated hardware component 10.

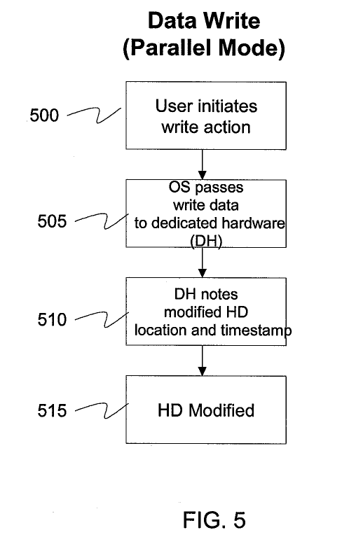

FIGS. 5-8 show exemplary flow diagrams implementing processing steps in accordance with embodiments of the invention. FIGS. 5-8 may equally represent high-level block diagrams of the invention. The processes of FIGS. 5-8 may take the form of an entirely hardware embodiment, an entirely software embodiment or an embodiment containing both hardware and software elements. In an embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any system that can contain, store, communicate, propagate, or transport the program for use by or in connection with the instruction execution system, system, or device. The medium can be an electronic, magnetic, optical, electromagnetic, infrared, or semiconductor system (or system or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

FIG. 5 shows data write operations in a parallel mode, in accordance with the invention. At step 500, the user initiates a write action. At step 505, the operating system passes the write application to the dedicated hardware component. At step 510, the dedicated hardware component notes the modified hard drive location, timestamps such notification and provides this information to the memory for logging. At step 515, the hard drive is modified.

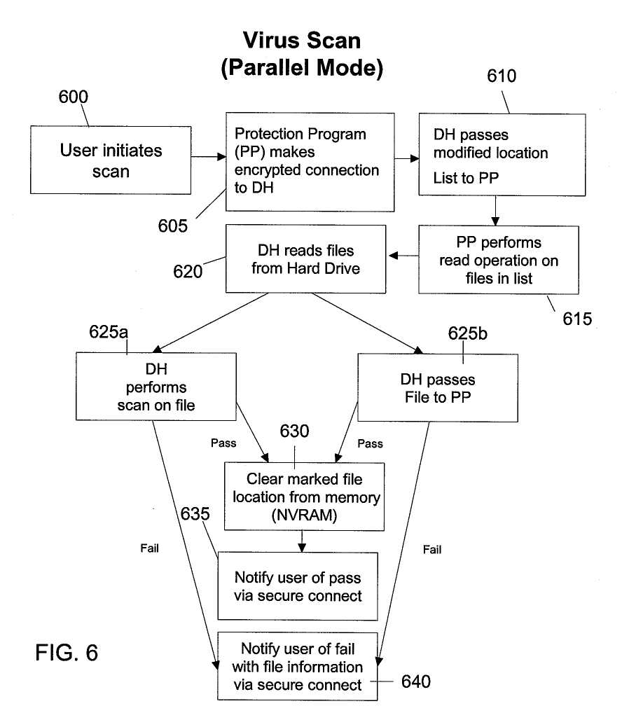

FIG. 6 shows a scan in parallel mode, in accordance with the invention. At step 600, the user initiates a scan. At step 605, the protection program connects to the dedicated hardware component via an encrypted connection. At step 610, the dedicated hardware component passes the modified location list to the protection program. More specifically, the dedicated hardware component provides the location of the modified files (files accessed and/or updated) to the protection program. At step 615, the protection program performs read operations on the files in the retrieved list. At step 620, the dedicated hardware component reads the files from the hard drive. Depending on the implementation, at step 625a, the dedicated hardware component will perform the scan on the files or, alternatively, at step 625b, the dedicated hardware component will pass the file to the protection program for scanning.

If the scan passes, at step 630, the memory will be cleared of the marked file and, at step 635, the user will be notified that the file has passed. This notification can be provided by a secure or encrypted connection. If the scan fails, the user will be notified of the failure with the file information, at step 640. Again, this notification may be provided by a secure or encrypted connection.

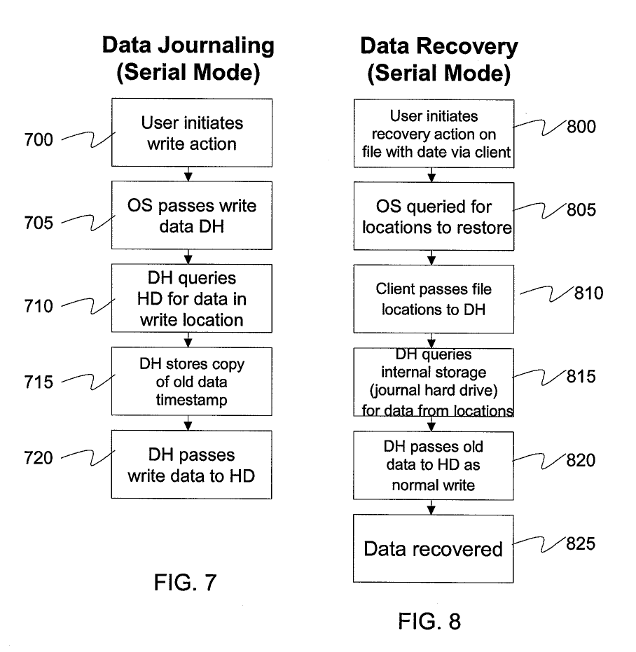

FIG. 7 shows data journaling in accordance with the invention. At step 700, the user initiates a write action. At step 705, the operating system passes the write operation to the dedicated hardware component. At step 710, the dedicated hardware component queries the hard drive for the data in the write location. At step 715, the dedicated hardware component stores a copy of the old data and timestamp thereof in an internal or external storage (e.g., hard drive 60). At step 720, the dedicated hardware component passes the write data to the hard drive.

FIG. 8 shows a data recovery in serial mode, in accordance with the invention. At step 800, the user initiates a recover action on the file by providing date information to a client (e.g., third party server or service provider). The operating system is queried for the locations to restore, at step 805. At step 810, the client passes the file locations to the dedicated hardware component. At step 815, the dedicated hardware component queries the internal or external storage (location of the old data) from data for locations. At step 820, the dedicated hardware component passes the old data to the hard drive for normal write operations. At step 825, the data is considered recovered.

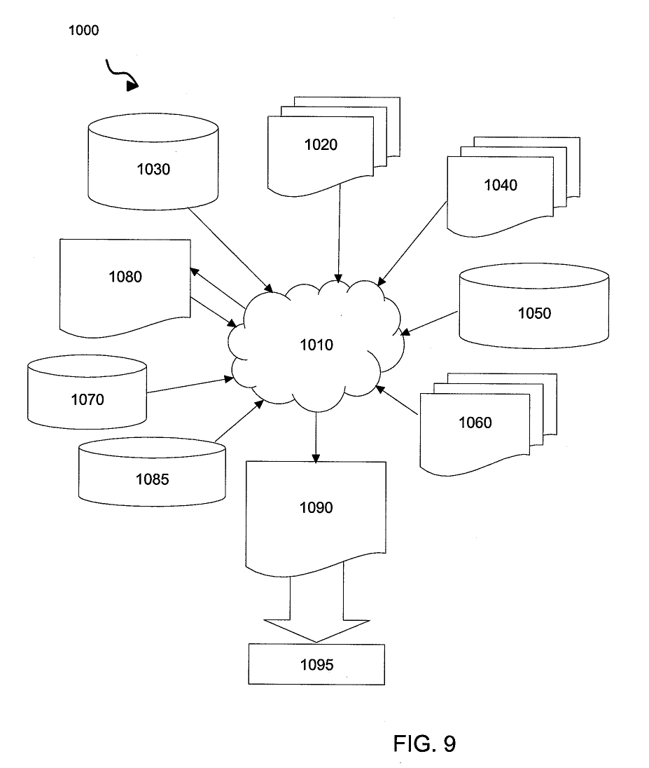

FIG. 9 is a flow diagram of a design process used in semiconductor design, manufacturing, and/or test. FIG. 9 shows a block diagram of an example design flow 1000. Design flow 1000 may vary depending on the type of IC being designed. For example, a design flow 1000 for building an application specific IC (ASIC) may differ from a design flow 1000 for designing a standard component. Design structure 1020 is preferably an input to a design process 1010 and may come from an IP provider, a core developer, or other design company or may be generated by the operator of the design flow, or from other sources. Design structure 1020 comprises the circuit and/or structure of the present invention, e.g., the dedicated hardware component 10, for example, in the form of schematics or HDL, a hardware-description language (e.g., Verilog, VHDL, C, etc.). Design structure 1020 may be contained on one or more machine readable medium. For example, design structure 1020 may be a text file or a graphical representation of the dedicated hardware component 10. Design process 1010 preferably synthesizes (or translates) the dedicated hardware component 10 into a netlist 1080, where netlist 1080 is, for example, a list of wires, transistors, logic gates, control circuits, I/O, models, etc. that describes the connections to other elements and circuits in an integrated circuit design and recorded on at least one of machine readable medium. This may be an iterative process in which netlist 1080 is resynthesized one or more times depending on design specifications and parameters for the circuit.

Design process 1010 may include using a variety of inputs; for example, inputs from library elements 1030 which may house a set of commonly used elements, circuits, and devices, including models, layouts, and symbolic representations, for a given manufacturing technology (e.g., different technology nodes, 32 nm, 45 nm, 90 nm, etc.), design specifications 1040, characterization data 1050, verification data 1060, design rules 1070, and test data files 1085 (which may include test patterns and other testing information). Design process 1010 may further include, for example, standard circuit design processes such as timing analysis, verification, design rule checking, place and route operations, etc. One of ordinary skill in the art of integrated circuit design can appreciate the extent of possible electronic design automation tools and applications used in design process 1010 without deviating from the scope and spirit of the invention. The design structure of the invention is not limited to any specific design flow.

Design process 1010 preferably translates an embodiment of the invention as shown in the accompanying figures such as, for example, FIG. 1, along with any additional integrated circuit design or data (if applicable), into a second design structure 1090. Design structure 1090 resides on a storage medium in a data format used for the exchange of layout data of integrated circuits (e.g. information stored in a GDSII (GDS2), GL1, OASIS, or any other suitable format for storing such design structures). Design structure 1090 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in the accompanying figures such as, for example, FIG. 1. Design structure 1090 may then proceed to a stage 1095 where, for example, design structure 1090: proceeds to tape-out, is released to manufacturing, is released to a mask house, is sent to another design house, is sent back to the customer, etc.

The circuit as described above is part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed. Moreover, the process as described above is used in the fabrication of integrated circuit chips.

While the invention has been described in terms of exemplary embodiments, those skilled in the art will recognize that the invention can be practiced with modifications and in the spirit and scope of the appended claims.

What is claimed:

1. A design structure embodied in a machine readable medium for designing, manufacturing, or testing a design, the design structure comprising:
means for tracking modified locations of a hard drive; and
means for providing a list of the modified locations to a protection program independent of an operating system, the modified locations being a subset of files of the hard drive.

2. The design structure of claim 1, wherein the design structure comprises a netlist, which describes the circuit.

3. The design structure of claim 1, wherein the design structure resides on storage medium as a data format used for the exchange of layout data of integrated circuits.

4. The design structure of claim 1, wherein the design structure includes at least one of test data files, characterization data, verification data, or design specifications.

5. A design structure embodied in a machine readable medium for designing, manufacturing, or testing a design, the design structure comprising:
a memory comprising content, the content being at least a list of files which have been modified within a predetermined period of time, the list of files being a subset of files of a hard drive;
a dedicated hardware component configured to track the files which have been modified and provide a location of the files to the memory; and
a communication link between the dedicated hardware component and a protection program to provide the protection program the subset of files of the hard drive as referenced by the memory content.
